(19) United States
(12) Patent Application Publication
(10) Pub. No.: US 2026/0005871 A1
(43) Pub. Date: Jan. 1, 2026

(54) POST-QUANTUM AUTHENTICATION WITH PROBABILISTIC DATA STRUCTURES

(71) Applicant: UNIVERSITY OF SOUTH FLORIDA, Tampa, FL (US)

(72) Inventors: Attila Altay YAVUZ, Tampa, FL (US); Kiarash SEDGHIGHADIKOLAEI, Tampa, FL (US)

(21) Appl. No.: 19/255,648

(22) Filed: Jun. 30, 2025

Related U.S. Application Data
(60) Provisional application No. 63/665,539, filed on Jun. 28, 2024.

(51) Int. Cl. H04L 9/32; H04L 9/30

(52) U.S. Cl. CPC H04L 9/3247; H04L 9/304; H04L 9/3066; H04L 9/3234

(57) ABSTRACT

A method for generating a digital signature for a message involves obtaining the message and a signing private key. The signing private key is divided into a plurality of indexed values. A counter value is identified to provide a set of partitions with unique integer interpretations through at least one round of combining the message with the counter value, hashing the combined message and counter value to generate a hash, reducing the hash to a predetermined length to generate a reduced hash, and partitioning the reduced hash into a plurality of partitions. If the partitions are not interpretable as a set of unique integers, the counter value is incremented for the next round. If the partitions are interpretable as a set of unique integers, the counter value is provided. A set of values from the signing key indexed by the unique integers is selected, and the digital signature comprising the selected set of values and the counter is outputted.

### CROSS-REFERENCE TO RELATED APPLICATION(S)

This application claims priority to U.S. Provisional Patent Application No. 63/665,539 filed on Jun. 28, 2024, the entire contents of which are incorporated herein by reference for all purposes.

### STATEMENT OF GOVERNMENT SUPPORT

This invention was made with government support under grant number CNS-2350213, awarded by the National Science Foundation. The government has certain rights in the invention.

### BACKGROUND

IoT devices, such as medical implants, autonomous vehicles, personal gadgets like smartwatches, and military equipment like aerial drones, are pivotal in advancing the intelligent infrastructure of emerging ubiquitous systems like the Internet of Things (IoT) and Wireless Sensor Networks (WSNs). IoT systems' extensive data acquisition and control capabilities underscore the need for highly efficient protocols to ensure data integrity upon its immediate availability. Additionally, these infrastructures and IoT systems rely on Next Generation (NextG) networks incorporating mobile devices and must meet real-time criteria for safety. Thus, these technologies face the challenge of safeguarding the authentication and integrity of such NextG networks while ensuring efficient operation.

As an example, time-critical (delay-aware) operations are essential for various real-life applications. For example, in vehicular networks (e.g., as an extension of the Internet of Vehicles (IoV)), rapid (immediate) verification of messages across vehicles and infrastructure is vital for prompt responses to events such as sudden braking. In IoV, ensuring the authenticity and integrity of the messages exchanged across the entities is critical to prevent potentially devastating attacks such as message tampering, false message injection, impersonation, and man-in-the-attack. To mitigate these vulnerabilities, broadcast authentication methods are sometimes used to prevent impersonation attacks and verify message integrity. Among those, digital signatures are one of the essential tools to ensure a scalable broadcast authentication. In addition to vehicular networks, efficient authentication mechanisms are essential for transmitting command and control messages within time-sensitive micro-smart grids, the CAN bus standard in automotive communication systems, edge-based applications, power grids, battery-powered aerial drones, etc.

### SUMMARY

In some aspects, the techniques described herein relate to a method of generating a digital signature for a message, including: obtaining the message; obtaining a signing private key; dividing the signing private key into a plurality of indexed values; identifying a counter value that provides a set of partitions having unique integer interpretations via at least one round of: combining the message with the counter value; hashing the combined message and the counter value to generate a hash; reducing the hash to a predetermined length to generate a reduced hash; partitioning the reduced hash into a plurality of partitions; if the plurality of partitions are not interpretable as a set of unique integers, incrementing the counter value for a next round; if the plurality of partitions are interpretable as a set of unique integers, providing the counter value; selecting a set of values from the signing key indexed by the unique integers; and outputting the digital signature including the selected set of values and the counter.

In some aspects, the techniques described herein relate to a method, further including: generating a plurality of signing private and public keys; generating a Merkle tree using the signing public keys; and providing the root of the tree as a global public key; wherein the digital signature further includes an authentication path to the root.

In some aspects, the techniques described herein relate to a method, further including: generating a master key; generating a plurality of sets of random bit strings as signing private keys using the master key; generating a bit vector using one-hash bloom filters applied to each signing private key; generating the Merkle tree using the plurality of bit vectors.

In some aspects, the techniques described herein relate to a method, further including: determining a seed value for a current signing round; generating the signing private key using the seed value; and generating a pad for a signing public key corresponding to the signing private key by hashing the seed value for the current signing round; wherein the digital signature further includes the seed value for the current signing round.

In some aspects, the techniques described herein relate to a method, further including: generating a plurality of signing public keys for future verification operations; generating an elliptic-curve-based signature for the plurality of signing public keys; and generating an error correction code for the plurality of signing public keys; wherein the digital signature further includes the plurality of signing public keys, the elliptic-curve-based signature, and the error correction code.

In some aspects, the techniques described herein relate to a method, further including: obtaining a Merkle tree over random values; generating in each of a plurality of signing rounds, the signing private and public keys; generating a random collision value using a chameleon hash function based on the public key and a previously generated random value; wherein the digital signature further includes the collision value.

In some aspects, the techniques described herein relate to a method, further including: generating the signing private key as t random bit strings indexed by t; and generating a public key as a bit vector by inserting the t random bit strings into the bit vector using a one-hash bloom filter.

In some aspects, the techniques described herein relate to a method of validating a digitally signed message, including: obtaining a public key including an indexed bit vector including a plurality of set bits and a plurality of unset bits; receiving the digitally signed message including a message and a digital signature, the digital signature including a counter value and a set of values selected from a signing private key including a plurality of indexed values; combining the message and the counter value; hashing the combined message and counter value to generate a hash; generating a reduced hash based on the hash; partitioning the reduced hash into a plurality of partitions that are interpretable as integers; if the integers are not unique, identifying the signature as invalid; for each respective partition of the plurality of partitions, hashing each value of the set of values and performing a modulo operation the hashed value using the integer corresponding to a partition size of the respective partition to determine a respective set of indices; if any of the indices of the bit vector are not set, identifying the message as invalid.

In some aspects, the techniques described herein relate to a method, wherein the signing public key includes a root of a Merkle tree, the method further including: receiving an authentication path; validating the authentication path based on the root and a maintained state; if the authentication path is not valid, identifying the signature as invalid.

In some aspects, the techniques described herein relate to a method, further including, responsive to the authentication path not being valid, advancing the maintained state to a next maintained state.

In some aspects, the techniques described herein relate to a method, wherein the digital signature includes a pad seed, the method further including: inputting the pad seed to a pseudorandom function to determine an extended pad; and generating an unmasked public key including a bit vector by combining the extended pad with the public key.

In some aspects, the techniques described herein relate to a method, further including: storing an initial seed in a trusted execution environment (TEE); determining a current seed for a current verification round; generating a signing private key in the TEE using the current seed; and generating the signing public key in the TEE using the private key.

In some aspects, the techniques described herein relate to a method, further including: receiving a plurality of signing public keys, an elliptic-curve-based signature for the plurality of public keys, and an error correction code for the plurality of public keys; validating the plurality of signing public keys using the elliptic-curve-based signature; storing the plurality of signing public keys; and selecting a next public key for signature verification.

In some aspects, the techniques described herein relate to a method, wherein the digital signature further includes a collision value: receiving a public key for a chameleon hash function; and verifying a corresponding private key for the chameleon hash function using the signing public key and the collision value.

In some aspects, the techniques described herein relate to a non-transitory computer readable medium storing executable instructions to sign a message by: obtaining the message; obtaining a signing private key; dividing the signing private key into a plurality of indexed values; identifying a counter value that provides a set of partitions having unique integer interpretations via at least one round of: combining the message with the counter value; hashing the combined message and the counter value to generate a hash; reducing the hash to a predetermined length to generate a reduced hash; partitioning the reduced hash into a plurality of partitions; if the plurality of partitions are not interpretable as a set of unique integers, incrementing the counter value for a next round; if the plurality of partitions are interpretable as a set of unique integers, providing the counter value; selecting a set of values from the signing key indexed by the unique integers; and outputting the digital signature including the selected set of values and the counter.

In some aspects, the techniques described herein relate to a non-transitory computer readable medium storing executable instructions to sign the message by: generating a plurality of signing private and public keys; generating a Merkle tree using the signing public keys; and providing the root of the tree as a global public key; wherein the digital signature further includes an authentication path to the root.

In some aspects, the techniques described herein relate to a non-transitory computer readable medium storing executable instructions to sign the message by: determining a seed value for a current signing round; generating the signing private key using the seed value; and generating a pad for a signing public key corresponding to the signing private key by hashing the seed value for the current signing round; wherein the digital signature further includes the seed value for the current signing round.

In some aspects, the techniques described herein relate to a non-transitory computer readable medium storing executable instructions to sign the message by: obtaining a Merkle tree over random values; generating in each of a plurality of signing rounds, the signing private and public keys; generating a random collision value using a chameleon hash function based on the public key and a previously generated random value; wherein the digital signature further includes the collision value.

In some aspects, the techniques described herein relate to a non-transitory computer readable medium storing executable instructions to validate a second digitally signed message by: obtaining a second public key including an indexed bit vector including a second plurality of set bits and a second plurality of unset bits; receiving the second digitally signed message including a second message and a second digital signature, the second digital signature including a second counter value and a second set of values selected from a second signing private key including a plurality of indexed values; combining the second message and the second counter value; hashing the combined second message and second counter value to generate a second hash; generating a second reduced hash based on the second hash; partitioning the second reduced hash into a second plurality of partitions that are interpretable as integers; if the integers of the second plurality are not unique, identifying the second signature as invalid; for each respective partition of the second plurality of partitions, hashing each value of the second set of values and performing a modulo operation on the hashed value using the integer corresponding to a partition size of the respective partition to determine a respective set of indices; if any of the indices of the second bit vector are not set, identifying the second message as invalid.

### BRIEF DESCRIPTION OF THE DRAWINGS

To describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings.

FIG. 1 illustrates an example use of a OHBF.

FIG. 2 illustrates an example environment in which various aspects of examples of the disclosed technology will be described.

FIGS. 3-8 present Tables 1-6, respectively.

FIG. 9 illustrates certain components that may be included within a computer system, which may be used to control features according to embodiments of the present disclosure, such as the features discussed with reference to FIGS. 1-8.

Before explaining the disclosed embodiment of this disclosure in detail, it is to be understood that the invention is not limited in its application to the details of the particular arrangement shown, as the invention is capable of other embodiments. Example embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While the subject disclosure applies to embodiments in many different forms, there are shown in the drawings and will be described in detail herein specific embodiments with the understanding that the present disclosure is an example of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention. In the description of the drawings, unless explicitly stated otherwise, like reference numerals refer to like elements.

IoT devices, such as medical implants, personal gadgets like smartwatches, and military equipment like aerial drones, are pivotal in advancing the intelligent infrastructure of emerging ubiquitous systems like the Internet of Things (IoT) and Wireless Sensor Networks (WSNs). IoT systems' extensive data acquisition and control capabilities underscore the need for highly efficient protocols to ensure data integrity upon its immediate availability. Additionally, these infrastructures and IoT systems rely on Next Generation (NextG) networks incorporating mobile devices and must meet real-time criteria for safety. Thus, safeguarding the authentication and integrity of such NextG networks while ensuring efficient operation remains paramount.

The time-sensitive nature of applications like vehicular networks, aerial drones, etc, results in immediate transmission of messages once an endpoint creates them. Subsequently, these messages may be efficiently verified by the receiving endpoint. This also leads to some unique authentication characteristics, in which the transmitted messages may remain secure only for a short period. For example, when a command is sent over a smart-grid system, the message and its digital signature may be transmitted and verified within a few milliseconds (at most). Beyond this time duration, the adversary loses its advantage of exploiting the delay-aware aspects of the application (e.g., triggering a malicious action on the smart grid, influencing system behavior timely). Hence, time-valid applications, such as command authentications in smart grid and vehicular systems, may prioritize high-speed over long-term security as long as the security mechanism remains secure in a designated time interval. The prioritization of speedy authentication over long-term security is to ensure safety by minimizing the impact of the authentication overhead on the system's reliability. Note that, as discussed in the following sections, after real-time (delay-aware) verification under time-valid constraints, one can later also ensure the long-term security of the messages for historical validation purposes (e.g., to enable audits). Hence, one of the main focuses of our work is to enable fast and secure digital signature functionality that may remain valid only for a limited amount of time, yet can also counter highly resourceful adversaries under such conditions.

High-speed authentication benefits real-time applications by minimizing end-to-end delay, which is mainly the compromise of the time required by generating, transmitting, and verifying signatures. Hence, a computationally efficient digital signature with short tag sizes is useful for delay-aware applications that follow the time valid concept. In addition to minimizing delay, some IoT end devices typically possess limited resources, including less powerful CPUs and inadequate power reserves for intensive computations. Therefore, an efficient authentication mechanism for these infrastructures is critical.

Given that numerous envisioned time valid applications encompass many devices and systems, it becomes important for devices within these networks to respond to or initiate a considerable volume of authentications quickly within a restricted time frame. Scalable broadcast authentication is usually achieved via digital signatures. However, certain digital signatures offer specialized and enhanced security features, albeit at a higher cost, due to the additional operations compared to their traditional counterparts.

The emergence of quantum computers poses a significant threat to traditional cryptosystems due to Shor's algorithm, capable of efficiently solving the hard problems underlying these systems, such as the (elliptic curve) discrete logarithm problem and integer factorization. In response, to standardize post-quantum secure digital signatures include schemes such as: CRYSTALS-Dilithium, FALCON, and SPHINCS+. However, while efficient quantum-safe signature schemes like Dilithium offer robust security, their computational demands make them impractical for low-end IoT devices. Accordingly, the described technology supports IoT systems that prioritize post-quantum security solutions tailored for time valid settings, providing security for short durations while maintaining computational and communication efficiency.

Compromise-resiliency is a strong security feature that permits a cryptographic primitive to retain some security even after the keying material is compromised. Specifically, a forward-secure digital signature guarantees that the signatures generated before the key compromise happens remain unforgeable. This property can be highly beneficial for IoT applications, wherein the IoT end devices are vulnerable to key compromises.

Another line in digital signature construction involves utilizing hash functions (hash-based signatures), which are post-quantum secure. Hash-based signatures have attracted increased attention due to the conciseness and efficiency of their underlying hash functions. Their advantage lies in balancing signature size, execution time, and memory overhead to fulfill specific application requirements. For instance, while some hash-based signatures offer efficient signature generation and verification (with a limited number of signings), others provide high security with longer usage but entail very large signature sizes and costly signing processes.

In some implementations, the system model may be tailored to time-valid systems such as vehicular networks and micro-smart grids. These systems typically involve IoT end devices with constrained resources, including limited CPU power and insufficient power reserves. Messages must be promptly transmitted and authenticated efficiently. Scalability against significant authentication requests and achieving time-valid post-quantum security may be important within such networks. One prominent architecture may be a smart-grid application, in which several smart meters periodically report their measures to the control center. In this use case, lightweight signing and fast verification may be achieved to ensure delay awareness and compatibility with smart-meter low-end hardware.

The described technology may be applicable to a large variety of hash-based digital signatures, such as:

### One-Time Signatures (OTS):

The first OTS was proposed by Lamport in 1979, aiming to minimize calculation costs and storage requirements. Merkle enhanced Lamport's scheme by introducing an additional checksum value, recording the number of zero bits in each message before signing, and reducing signature and key pair sizes. Subsequently, Winternitz OTS (W-OTS) further refined the Lamport and Merkle schemes, achieving even shorter signature and key pair sizes. However, W-OTS required additional hash evaluations. A subsequent advancement, W-OTS+, maintained a similar security level while producing even shorter signatures compared to previous schemes. These developments aimed to optimize signature sizes while balancing computational efficiency and security.

### Few-Time Signatures (FTS):

Hash-based FTSs enable multiple messages to be signed using the same key pair, although the security decreases with the number of signed messages. The first FTS was BiBa, which prioritized fast verification and small signature size but at the expense of signature generation time and public key size. Later, HORS extended the Lamport OTS by using Bos-Chaum signatures and cover-free families. With the vulnerability of HORS against using weak messages, PORS and FORS addressed this vulnerability by employing a pseudorandom subset obtained using a pseudorandom number generator. Moreover, HORS has been underlyingly used in schemes like HORST, HORSIC, HORSIC+, etc., in recent years. The properties of HORS have led to its use in developing authentication systems (e.g., TV-HORS) for time-sensitive multicast data, where minimizing end-to-end delay, ensuring computational and communication efficiency, and packet loss resiliency is vital.

### Many-Time Signatures (MTS):

A MTS uses one or more OTS/FTS schemes as its building block. Merkle Signature Scheme (MSS) is built upon WOTS and reduced key and signature sizes to a practical level and incorporated hash trees to allow for reusing a single public key for a specific number of times (many times). Some variants of MSS are XMSS, which reduced key and signature sizes and incorporated a more secure version of the hash tree. XMSS uses a compact variant of WOTS as its building block. More advanced MSS schemes, like XMSSMT, SPHINCS, and SPHINCS+, allow reusing a single public key for a polynomially unbounded number of times.

Notations: ∥ and |x| denote concatenation and the bit length of variable x, respectively. x [symbol] S means variable x is randomly selected from the finite set S using a uniform distribution. m∈{0, 1}* represents a message of any finite length.

$${\{ {q}_{i} \}}_{i = a}^{b}$$

denotes the set {qₐ, qₐ₊₁, . . . , q_{b}}. log x denotes log 2 H:{0, 1}*→{0,1}^{L} and h:{0, 3}*→{0,1}^{L′} denote cryptographic and non-cryptographic hash functions, respectively.

The described technology may be applied to various underlying digital signature schemes. For example, some implementations are described using the Hash to Obtain Random Subset (HORS) algorithm, which is defined by Algorithm 1:

Algorithm 1 HORS Digital Signature (HORS)

| | |
|---|---|
| | (sk, PK, [symbol] ) ← HORS.Kg( [symbol] ) |
| 1: | Given the security parameter [symbol] , generate the system-wide |
| | parameters I ← (l, k, t) |
| 2: | Generate [symbol] random [symbol] -bit strings {sᵢ}ᵢ₌₁^{l}: sᵢ [symbol] {0, 1}^{l}, ∀i ∈ [1, t] |
| 3: | Let [symbol] ← f(sᵢ), ∀i ∈ [1, t] where f(.) is a one-way function and we |
| | usually use H(.) |
| 4: | return the private key sk ← {sᵢ}ᵢ₌₁^{l}, public key PK ← { [symbol] }ᵢ₌₁^{l}, and |
| | the system-wide parameters I |
| | σ ← HORS.Sig(sk, m) |
| 1: | hash ← H(m) |
| 2: | Split hash into k substrings {hashⱼ}ⱼ₌₁^{k} such that \|hashⱼ\| = log t |
| 3: | Interpret each hashⱼ as an integer [symbol] , ∀j ∈ {1, 2, . . . , k} |
| 4: | return σ ← {sᵢ_{ⱼ}}ⱼ₌₁^{k} |
| | b ← HORS.Ver(PK, m, σ) |
| 1: | Repeat signature generation Step 1-3. |
| 2: | If f(s [symbol] ) = [symbol] , ∀j ∈ {1, 2, . . . , k} then return b = 1 (Verified) else |
| | return b = 0 (Not verified) |

[symbol]

indicates data missing or illegible when filed

The security of the HORS digital signature relies on the underlying secure hash function H being r-subset-resilient. The overall security (in terms of bits) against r-non-adaptive-message attacks, wherein an adversary seeks to forge a signature given r message-signature pairs, is determined as follows:

$$κ = min ( \frac{k log t}{2} , \frac{L}{2} , k ( log t - log k - log r ) ) .$$

As the equation illustrates, depending on the chosen values for k and t, there are instances where the product k log t is less than L. In such scenarios, the hash function's security decreases from L/2 bits to the extent covered by k log t, resulting in a reduced security level (k log t)/2 bits.

Some implementations of the described technology utilize a Probabilistic Data Structure (PDS), which employs condensed data representations to provide approximately correct responses to data queries, offering advantages across various applications such as web caches, databases, cognitive radio networks, etc. A O ne-hash Bloom Filter (OHBF) is a PDS that utilizes a bit vector bv[·] with size n, a non-cryptographic hash function h( ) with L′ bits of output, and comprises p partitions

$${\{ {P}_{i} \}}_{i = 1}^{p}$$

each of size nᵢ, satisfying Σnᵢ≥n and gcd(nᵢ, nⱼ)=1 for all i,j ∈[1, p]. OHBF offers enhanced efficiency in insertion and existence checks of an element eᵢ compared to the standard Bloom filter due to the singular application of h and performing p arithmetic modulo operations as opposed to conducting multiple hash evaluations.

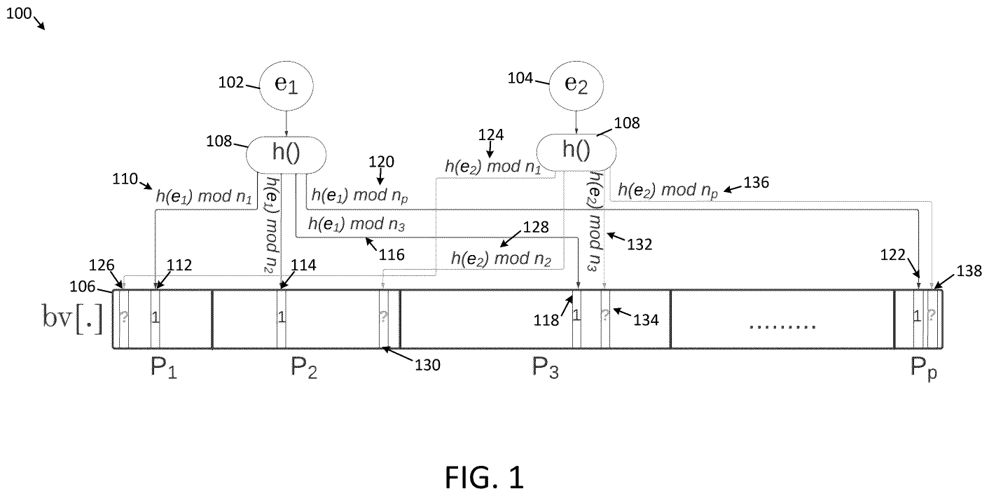

FIG. 1 illustrates an example use of a OHBF. In this example, a first element e₁ 102 is inserted into a bit vector bv[·] 106 and the existence of a second element e₂ 104 in the bit vector 106 is checked. For instance, e₁ 102 and e₂ 104 may comprise a sequence of bits, such as a message or chunk of a message encoded in a binary number (which may interpreted or parsed into one or more integers). For example, either or both illustrated processes may be performed by messaging entities while exchanging digital signed messages, such as the examples described below.

The insertion process of element e₁ 102 includes hashing the element to generate a number h(e₁) using a noncryptographic hash function 108. In further examples, the hash function may be a cryptographic hash function H(·). The bit vector 106 is partitioned into a predetermined number of partitions p, labeled P₁ . . . Pₚ. Each partition corresponds to an integer n₁ . . . nₚ, where the integers are pairwise coprime (which includes prime numbers themselves).

Insertion further includes performing p modulo operations on h(e₁) using each integer n₁ . . . nₚ as the corresponding modulus and setting a bit at the location defined by the result. For example, as illustrated, h(e₁) mod n₁ 110 defines location 112 within partition P₁, h(e₁) mod n₂ 114 defines location 114 within partition P₂, h(e₁) mod n₃ 116 defines location 118 within partition P₃, . . . , and h(e₁) mod nₚ 120 defines location 122 within partition Pₚ. Accordingly, the bit at each location 112, 114, 118, . . . , 122 is set (e.g., to 1 for a 0-initialized bit vector).

Existence checking follows a similar process. An element e₂ is hashed using hash function h(·) 108 and the modulo under n₁ . . . nₚ of the result h(e₂) are taken. Each modulo operation defines a location in the corresponding partition P₁, . . . ,Pₚ, which is read. If the bit at each location is set (e.g., to 1), then e₂ exists within the bit vector 106. For example, as illustrated, h(e₂) mod n₁ 124 defines location 126 within partition P₁, h(e₂) mod n₂ 128 defines location 130 within partition P₂, h(e₂) mod n₃ 132 defines location 134 within partition P₃, . . . , and h(e₂) mod nₚ 136 defines location 138 within partition Pₚ. Accordingly, if bit at each location 126, 130, 134, . . . , 138 is set, e₂ is found in the bit vector 106, whereas if at least one bit is not set, e₂ is determined to be absent from the bit vector 106.

Given the assumption that the h( ) uniformly distributes its domain to its range, the false positive probability associated with the insertion of N items is as follows:

$${f}_{OHBF} = {( 1 - \sqrt[p]{{\prod }_{i = 1}^{p} {e}^{- \frac{N}{{n}_{i}}}} )}^{- p} .$$

The security of the OHBF will be defined as the combination of the security of the non-cryptographic hash function and the false positive probability:

$$κ = min ( \frac{{L}^{′}}{2} , {log ( 1 - \sqrt[p]{{\prod }_{i = 1}^{p} {e}^{- \frac{N}{{n}_{i}}}} )}^{- p} ) .$$

A Merkle tree is a complete binary tree with a secure hash function H and an assignment ϕ:n→{0, 1}^{k}, which maps a node to a string. For two child nodes, n_{left} and n_{right}, the parent interior node is a one-way function of its children defined as follows:

$$ϕ ( {n}_{parent} ) = H ( ϕ ( {n}_{left} ) ‖ ϕ ( {n}_{right} ) ) .$$

For each leaf leaf, the value of ϕ(leaf) is a one-way function of some leaf preimage, and often, where H is used to compute the leaves. Using the method above, the rest of the nodes can be constructed using the TREEHASH algorithm, and the Root of the tree as the authentication commitment can be outputted.

Beyond extracting the Root, another aim is to efficiently obtain the authentication path for each leaf. In some examples, (e.g., to balance the computational overhead of using TREEHASH for authenticating each node and the memory overhead associated with storing the entire tree), a Fractal Merkle tree representation and traversal may be applied. This method involves maintaining in memory a subset of subtrees Eᵣ={Existᵢ}^{T}, where T represents the number of subtree levels responsible for authenticating specific leaves for round r. Upon the authentication of all those nodes, Eᵣ evolves into

$${E}_{r + 1} = {\{ {Desire}_{i} \}}_{i = 1}^{T}$$

and is removed from memory. Eᵣ₊₁ encompasses another subset of subtrees (desire subtrees) capable of authenticating a different group of leaves.

As used herein, the process of constructing a Merkle tree on top of N data blocks dᵢ using the above method as algorithm

$$MHT . build ( {\{ {d}_{i} \}}_{i = 1}^{N} ) ,$$

extracting the authentication path to the root for data block dᵢ as MHT.auth(dᵢ), and verifying the authentication path Path for dᵢ as MHT.authver(dᵢ, Path). Moreover, the algorithm for evolving Eᵣ to Eᵣ₊₁ is noted as Eᵣ₊₁←MHT.evolve(Eᵣ).

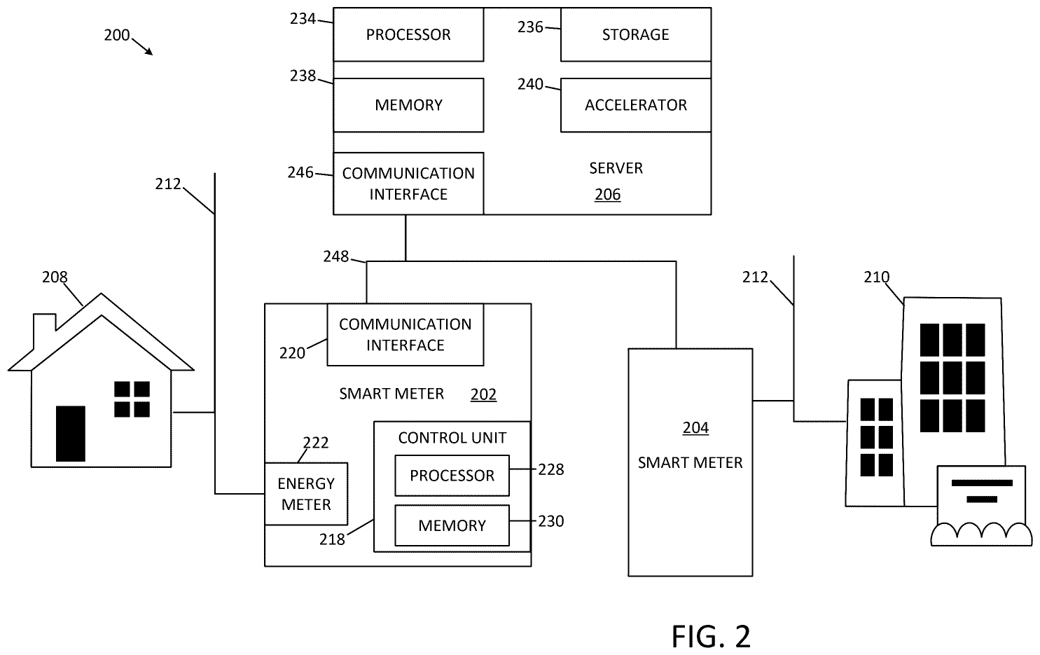

FIG. 2 illustrates an example environment 200 in which various aspects of examples of the disclosed technology will be described. In this example, a plurality of smart meters 202, 204, communicate 230 with a server 206. For example, server 206 may be a component of a utility control center or the like and smart meters 202, 204 may monitor power delivery to locations such as domicile 208, or enterprise 210 via mains power delivery 212.

Although particular algorithms and methods will be described with respect to smart-meter environment 200, the described technology may be applicable to any scenario where time-valid signing can be useful, such as where real-time authentication and data integrity are required. For instance, time-valid signing can be used in banking transaction verifications to authenticate and ensure the integrity of transaction data in real-time, providing a secure and reliable method for verifying the legitimacy of financial transactions.

Another such scenario is in medical implants, where time-valid signing ensures the authentication and integrity of data transmitted from the implants. These devices often operate in real-time and require immediate verification of data to ensure patient safety and accurate monitoring. Similarly, in wearable technology like smartwatches, time-valid signing can be used to authenticate health data and other sensitive information. Another scenario where time-valid signing is beneficial is in aerial drones, especially in military applications. Time-valid signing ensures that command and control messages are authenticated and verified in real-time. In vehicular networks, time-valid signing can be used to authenticate messages exchanged between vehicles and infrastructure.

Time-valid signing is also applicable in micro-smart grids, where it can be used to authenticate command and control messages. This ensures that the messages are transmitted and verified within a few milliseconds, minimizing the impact of authentication overhead on the system's reliability. In edge-based applications, time-valid signing can be used to authenticate data transmitted between edge devices and central servers. This ensures that the data is verified quickly, providing reliable information for decision-making and minimizing end-to-end delay.

Furthermore, time-valid signing can be used in power grids to authenticate data transmitted between different components of the grid. This ensures that the data is verified quickly, providing reliable information for grid management and minimizing the impact of authentication overhead on the system's reliability. Additionally, time-valid signing can be applied to battery-powered aerial drones to authenticate command and control messages. This ensures that the messages are transmitted and verified quickly, providing reliable information for drone operation and minimizing the impact of authentication overhead on the system's reliability.

Returning to the smart meter example environment 200, a smart meter 202 may comprise various circuitry and components to monitor the power delivered to building 208 via utility power 212. For example, smart meter 202 may comprise energy meter circuitry 222. In some implementations, the energy metering circuitry 222 within a smart meter 202 may include components such as current transformers, voltage sensors, and analog-to-digital converters. These components measure the electrical parameters and convert them into digital signals. The digital signals are then processed by the metering circuitry 222 to calculate energy consumption. The resulting data is subsequently delivered as an output to the microcontroller within the smart meter for further processing and communication. Of course, in other examples, various metering operations may be performed by other components, such as control unit 218 (e.g., a microcontroller).

In some implementations, the control unit 218 of a smart meter receives data from the energy metering circuitry. The control unit 218 includes a processor 228 and a memory 230. The memory 230 stores instructions executable by the processor 228. Upon receiving the data from the energy metering circuitry, the processor 228 processes the data and generates messages to convey the energy consumption information. These messages are stored in the memory 230. The control unit 218 then digitally signs the messages using any of the various techniques described below. This ensures the authenticity and integrity of the data being transmitted. The digitally signed messages are then transmitted to the relevant systems or devices for further processing and communication. In some implementations, the control unit 218 may include alternative components such as field-programmable gate arrays (FPGAs), application-specific integrated circuits (ASICs), or accelerators. For example, an ASIC comprising digital logic may be used to perform the described steps.

In some implementations, the communication interface 220 within smart meter 202 may include various modules and protocols to facilitate data transmission and connectivity. For example, the communication interface 220 may incorporate a Wi-Fi module to enable wireless communication with local networks, allowing for remote monitoring and control of the smart meter 202. In some implementations, Bluetooth connectivity may be included to facilitate short-range communication with nearby devices, such as smartphones or tablets. Additionally, the communication interface 220 may support wide area network (WAN) connectivity, enabling the smart meter 202 to communicate with centralized systems over long distances. Power line communication (PLC) interfaces may also be utilized, allowing data transmission over existing electrical wiring, which can be particularly useful in environments where wireless signals are weak or unreliable. Other wired communication protocols, such as Ethernet or serial communication, may be implemented to provide robust and secure data transmission options for the smart meter 202.

In some implementations, server 206 within a smart metering system may receive communications from smart meter 202 via link 248 and communication interface 246. The server 206 includes various components such as processor 234, memory 238, storage 236, communication interface 246, and accelerator 240.

Processor 234 may execute instructions stored in memory 238 to process data received from smart meter 202. For example, the processor 234 may analyze energy consumption data and generate reports or alerts based on predefined criteria. Memory 238 may store instructions executable by processor 234, as well as temporary data and configuration settings. In some implementations, storage 236 may provide long-term data storage for historical energy consumption data, user profiles, and other relevant information.

Communication interface 246 may include various modules and protocols to facilitate data transmission and connectivity. For example, communication interface 246 may incorporate a Wi-Fi module to enable wireless communication with local networks, allowing for remote monitoring and control of server 206. In some implementations, Bluetooth connectivity may be included to facilitate short-range communication with nearby devices. Additionally, communication interface 246 may support wide area network (WAN) connectivity, enabling server 206 to communicate with centralized systems over long distances. Power line communication (PLC) interfaces may also be utilized, allowing data transmission over existing electrical wiring. Other wired communication protocols, such as Ethernet or serial communication, may be implemented to provide robust and secure data transmission options for server 206.

Accelerator 240 may include components such as field-programmable gate arrays (FPGAs), application-specific integrated circuits (ASICs), or other specialized hardware to enhance the performance and efficiency of server 206. For example, an ASIC comprising digital logic may be used to perform specific processing tasks more efficiently than a general-purpose processor. These alternative components can be used to accelerate data processing, encryption, and other computationally intensive tasks within server 206.

In some implementations, server 206 may receive communications from smart meter 202 via link 248 and communication interface 246. The received data may be processed by processor 234, stored in memory 238 and storage 236, and transmitted to other systems or devices via communication interface 246. The use of accelerator 240 may further enhance the performance and efficiency of server 206 in processing and transmitting data within the smart metering system. Accelerator 240 may include components such as field-programmable gate arrays (FPGAs), application-specific integrated circuits (ASICs), or other specialized hardware to enhance the performance and efficiency of server 206. For example, accelerator 240 may comprise an ASIC comprising digital logic to perform all or portions of the various techniques described herein.

In some implementations, server 206 may receive communications from smart meter 202 via link 248 and communication interface 246. The received data may be processed by processor 234, stored in memory 238 and storage 236, and transmitted to other systems or devices via communication interface 246.

While examples may be described with respect to smart meter 202 signing digital messages and server 206 verifying those messages, any entity may serve any role within the smart metering system. For example, server 206 could be the message signer while smart meter 202 could be the message verifier. In such scenarios, smart meter 202 may verify messages received from server 206 for purposes such as reprogramming firmware or receiving commands. This flexibility allows for various configurations and roles within the smart metering system, ensuring adaptability to different operational requirements and use cases.

In another example, a multi-hop distribution system may be implemented where smart meter 204 sends messages to smart meter 202, which then forwards those messages to server 206. In this scenario, smart meter 204 may act as an intermediary, collecting data from various sources and transmitting it to smart meter 202. Smart meter 202 may then verify the authenticity and integrity of the received messages before forwarding them to server 206 for further processing. This multi-hop configuration can be useful in environments where direct communication between smart meters and servers is not feasible due to distance or network limitations.

Additionally, smart meter 202 may serve as a verifier for messages received from other smart meters or devices within the network. For example, smart meter 202 could verify messages from smart meter 204 related to energy consumption data, ensuring that the data is accurate and has not been tampered with. Once verified, smart meter 202 can aggregate the data and transmit it to server 206 for further analysis and storage.

In some implementations, server 206 may also act as a signer for messages sent to smart meter 202. For example, server 206 could sign firmware updates or configuration commands before transmitting them to smart meter 202. Smart meter 202 would then verify the authenticity of the signed messages before applying the updates or executing the commands. This ensures that only authorized updates and commands are applied to the smart meter, enhancing the security and reliability of the system.

In some implementations, various parameters may be received from other, non-illustrated components within the smart metering system. For example, these parameters could include configuration settings, security credentials, or operational commands that are necessary for the proper functioning of the system. Alternatively, such system parameters might be received from server 206. Server 206 may transmit these parameters to smart meter 202 or other components within the system to ensure synchronization and proper operation. Additionally, smart meter 202 may receive the current time from an external entity, such as a time server, to ensure accurate time-stamping of messages and synchronization across the system. In some implementations, smart meter 202 may be preprogrammed with various settings, security credentials, and security levels for different messages.

In some implementations, effective authentication mechanisms in time-valid contexts, such as banking transaction verifications and vehicular network communications, may be created using a series of novel post-quantum time-valid signatures. These implementations may build these schemes based on HORS digital signature, which serves as the cornerstone for numerous contemporary FTSs and MTSs, enhancing its efficiency for such use cases. Implementations may increase the speed of signature verification of HORS while also slightly improving its key generation and preserving its signature generation efficiency. Moreover, in addition to refining the HORS for time-valid applications, several multiple-time extensions of TVPD-HORS may be described. Among them, the details of the MTS-based version with TVPD-MHT-NHORS scheme may be described. Additionally, the details of the signer optimal N-time TVPD-HORS variant (SON-HORS) with various alternative improvements may be elaborated.

Implementations may provide faster signature verification by leveraging the computational efficiency of OHBF for insertion and existence check of elements, enhancing the signature verification process within HORS, especially for time-valid settings. The strategic use of OHBF as the One-way Function (OWF), combined with only k<t calls to OHBF in the signature verification, may permit TVPD-HORS to benefit from the efficiency of underlying non-cryptographic hash function and modular operations. For example, experiments described below provide improvement around 5× with lower parameters (e.g., 32-bit time-valid suited), 5× efficiency for moderate security levels (e.g., 64), and 2× with high-security parameters.

Implementations may provide faster key generation with equal signing performance. The principles outlined in signature verification may also benefit the key generation, with the only difference being in total t OHBF calls made. This may permit faster key generation compared to HORS in low to moderate security levels (e.g., 32-bits to 64-bits) and comparable performance for higher security levels (e.g., 96-bits and 128-bits). The scheme may maintain the signature generation efficiency of HORS at any security level.

Implementations may offer advanced security features with high performance. TVPD-HORS may offer security against weak message attacks, while SON-HORS may provide forward-secure signing with long-term public key security. Implementations may provide the opportunity to improve other HORS-based digital signatures. Since HORS serves as the underlying scheme for various FTSs and MTSs, the described utilization of OHBF may also enhance other HORS-based signatures like HORST, HORSIC, HORSIC+, etc.

In various applications, different components within a communication network may operate with any of the described roles. For example, the components within FIG. 2 can operate as a message verifier, message signer, or key generator. As examples, the control unit 218 can perform the role of the message signer, generating signatures for messages based on the TVPD-HORS scheme. The processor 228 can execute instructions to verify the authenticity of received messages, acting as the message verifier. The memory 230 can store the necessary parameters and keys for the key generation process, while the communication interface 246 can facilitate the transmission of signed and verified messages between devices.

One example set of messaging techniques is provided below as Algorithm 2. In some implementations, key generation involves generating system-wide parameters including l, k, and t as the HORS parameters, and p and n as the OHBF parameters, given the security parameter κ (e.g., TVPD-HORS.Kg step 1). The parameter TΔ signifies the time epoch (a time validity parameter), allowing control over the validity duration of a signature and is adjustable based on the application's needs (e.g., 15 minutes for a smart grid meter) (e.g., TVPD-HORS.Kg step 1). Parameter TΔ also impacts time-valid post-quantum security, as quantum computers often span geological locations, leading to variations in the time required for forging signatures due to geographical distances. The OHBF is created based on n and p, with all bits initialized to zero, indicating no elements have been inserted yet (e.g., TVPD-HORS.Kg step 2). Subsequently, the HORS private key is generated and inserted into the OHBF (e.g., TVPD-HORS.Kg steps 3-4). Based on the application's need, the signer and verifier time synchronization can be skipped for time-valid applications if high-security levels (e.g., 96-bit or 128-bit) are incorporated. Otherwise, the time of the signer (Ts) and verifier (Tv) are synchronized (e.g., TVPD-HORS.Kg steps 5-6). The private key of TVPD-HORS is the HORS's private key, and the public key is the OHBF (e.g., TVPD-HORS.Kg step 7).

In some implementations, signature generation is fundamentally similar to the HORS signature. The decision to sign a message is dependent on the security level. If the application is time-valid, the signer signs a message only in the time slice defined by TΔ (e.g., TVPD-HORS.Sig step 1). Otherwise, at high-security levels, the signer does not require a time slice restriction. To address the vulnerability of weak messages, the hash of the message is ensured to have k distinct parts aided by the Ctr variable (e.g., TVPD-HORS.Sig steps 2-3). Upon strengthening the message, the hash of it is truncated to match the time-valid security levels (e.g., TVPD-HORS.Sig step 3). The signature generation remains the same as the HORS, and the signature contains the Ctr variable (e.g., TVPD-HORS.Sig steps 4-8).

In some implementations, signature verification involves the verifier initially checking if the application is time-valid and if the verification falls within its corresponding epoch (e.g., TVPD-HORS.Ver step 1). If it does not, the verifier rejects the signature (e.g., TVPD-HORS.Ver step 1). Otherwise, it continues. In the case where the application is not time-valid, this step is skipped. The verifier checks if the received message is strong by testing the validity of the received Ctr (e.g., TVPD-HORS.Ver steps 2-3). If the Ctr is invalid, then the truncated hash does not contain k different parts (e.g., TVPD-HORS.Ver step 3). If the message is strong, the verifier further checks if the signature's portions (s′) exist in the public key (OHBF) (e.g., TVPD-HORS.Ver steps 4-5). If all the signature portions exist, then the signature is valid (e.g., TVPD-HORS.Ver step 5). Otherwise, the verifier rejects it (e.g., TVPD-HORS.Ver step 5).

| | Algorithm 2 Time Valid Probabilistic Data Structure HORS (TVPD-HORS) |
|---|---|
| | (sk, PK, I) ← TVPD-HORS.Kg(1^{κ}) |
| 1: | Given the time valid security parameter κ, generate the system-wide parameters I ← (l, k, t, p, n, T_{Δ}) |
| 2: | Generate bυ[.] containing p partitions {Pᵢ}ᵢ₌₁^{p} as stated in Definition 2 and set all the bits to 0 |
| 3: | $Generate t random l - bit strings {\{ {s}_{i} \}}_{i = 1}^{t} : {s}_{i} {←}^{\$} {\{ 0 , 1 \}}^{l} , ∀ i ∈ [ 1 , t ]$ |
| 4: | Insert sᵢ into the bυ[.] by setting the bit (h(sᵢ) mod nⱼ) of j^{th} partition to 1. ∀i ∈ [1, t] and ∀j ∈ [1, p] |
| 5: | if κ is not high security level then |
| 6: | Set the signer (Tₛ) and the verifier (Tᵥ) times to T₀ // T_{Δ} is κ dependent and can be for hours/days |
| 7: | $return the private key sk ← {\{ {s}_{i} \}}_{i = 1}^{t} , the public key PK ← bv [ . ] , and the system ‐ wide parameters I$ |
| | σ ← TVPD-HORS.Sig(sk, m) |
| 1: | Ctr ← 0 |
| 2: | if κ is high security level or Tₛ ∈ [T₀, T₀ + T_{Δ}] then |
| 3: | hush ← H (m\|\|Ctr) |
| 4: | hash′ ← Trunc(hash, k log t) // Truncate the hash to the length k log t based on the given κ |
| 5: | $Split the truncated hash , {hash}^{′} , into k substrings {\{ {hash}_{j}^{′} \}}_{j = 1}^{k} such that \vert {hash}_{j}^{′} \vert = log t$ |
| 6: | Interpret each hashⱼ′ as an integer iⱼ. ∀ j ∈ {1, 2, ... , k} |
| 7: | if there exist p, q ∈ {1, 2, ... , k} such that iₚ = i_{q} and p ≠ q then Ctr ← Ctr + 1 and goto 3 |
| 8: | $return σ ← ( {\{ {s}_{{i}_{j}} \}}_{j = 1}^{k} , Ctr )$ |
| | b ← TVPD-HORS.Ver(PK, m, σ) |
| 1: | $Recall that σ ← ( {\{ {s}_{i}^{l} \}}_{i = 1}^{k} , Ctr ) and PK ← b υ [ . ]$ |
| 2: | if κ is not high security level and Tᵥ ∉ [T₀, T₀ + T_{Δ}] then return b = 0 |
| 3: | hash ← H (m\|\|Ctr) |
| 4: | hash′ ← Trunc(hash, k log t) // Truncate the hash to the length k log t based on the given κ |
| 5: | $Split the truncated hash , {hash}^{′} , into k substrings {\{ {hash}_{j}^{′} \}}_{j = 1}^{k} , where \vert {hash}_{j}^{′} \vert = log t , ∀ j ∈ \{ 1 , 2 , … , k \}$ |
| 6: | Interpret each hashⱼ′ as an integer iⱼ, ∀ j ∈ {1, 2, ... , k} |
| 7: | if there exist p, q ∈ {1, 2, ... k} such that iₚ = i_{q} and p ≠ q then return b = 0 |
| 8: | if the bit indices (h(sⱼ′) mod nᵢ) of the i^{th} partition in the bυ[.] are set, ∀ j ∈ {1, 2, ... , k}, ∀i ∈ [1, p] then |
| 9: | return b = 1 |
| 10: | else |
| 11: | return b = 0 |

Another example application of the described technology is provided below with respect to Algorithm 3. In some implementations, the Time Valid Probabilistic Data Structure N-HORS (TVPD-MHT-NHORS) scheme extends the single-instance TVPD-HORS to accommodate multiple (N) instances of TVPD-HORS. The construction of this scheme involves leveraging the optimized Merkle tree, where a Merkle tree is created on top of N TVPD-HORS signature schemes. In each round, when selecting an instance of TVPD-HORS, its public key is authenticated using the Merkle tree. The second scheme is outlined in Algorithm 3 and is detailed as follows:

Key Generation: The key generation of TVPD-MHT-NHORS resembles the TVPD-HORS. In this phase, based on the given security parameter κ and the parameter N, N system-wide parameters for every TVPD-HORS are generated, and the time-valid parameter TΔ is chosen (e.g., TVPD-MHT-NHORS.Kg steps 1-2). Further, the master key msk is generated as a κ-bit string, which serves as the main seed for generating secondary seeds for the private keys (e.g., TVPD-MHT-NHORS.Kg step 3). The msk is stored at the signer's side. For each of the TVPD-HORS instances whose parameters are given by Iᵢ, an OHBF (Public key) is generated with all its bits set to zero (e.g., TVPD-MHT-NHORS.Kg step 6). Using the msk, the private keys are derived by utilizing a Pseudo-Random Function (PRF) (e.g., TVPD-MHT-NHORS.Kg step 7), and they are inserted into the OHBF (e.g., TVPD-MHT-NHORS.Kg step 8). All the public keys are collected as (\vec{BF}) and a Merkle tree is constructed on top of them, which serves to authenticate each of them later (e.g., TVPD-MHT-NHORS.Kg steps 9-10). The resulting Root is then outputted as the public key, transmitted to the verifier during the offline phase, while the exist tree (E1) is stored in the signer's memory (e.g., TVPD-MHT-NHORS.Kg steps 9-10). Lastly, if the application is time-valid, the signer and the verifier are synchronized, and their state is initialized (e.g., TVPD-MHT-NHORS.Kg steps 11-13).

Signature Generation: The signature generation phase resembles the TVPD-HORS scheme. First, the signer determines the state based on whether the application is time-valid. If the application is not time-valid, the signer uses the State counter variable as the state. Otherwise, it is computed based on the current signer time, TΔ, and the initial setup time (e.g., TVPD-MHT-NHORS.Sig step 1). The signer checks if the stored Er can authenticate the desired leaf (current state's TVPD-HORS). If it cannot, the Er is evolved to Er+1 using the MHT.evolve( ) (e.g., TVPD-MHT-NHORS.Sig step 2). Based on the current Er′, the TVPD-HORS's private and public keys are derived (e.g., TVPD-MHT-NHORS.Sig step 3), and the authentication path is computed for the public key (e.g., TVPD-MHT-NHORS.Sig step 4). The remaining steps of signature generation remain the same as TVPD-HORS (e.g., TVPD-MHT-NHORS.Sig steps 5-13). The state is updated based on the κ being high-security or low-security (e.g., TVPD-MHT-NHORS.Sig step 12), and the signature includes the Ctr variable, the authentication path for the TVPD-HORS public key, and the public key of the currently used TVPD-HORS.

Signature Verification: Upon receiving the message-signature pair, the verifier first determines the state based on the nature of the application. If the application is time-valid, the state is computed based on the current verifier's time Tv, initial synchronized time T0, and TΔ. Otherwise, the verifier uses the State counter variable (e.g., TVPD-MHT-NHORS.Ver step 2). Possessing the Merkle's root, the verifier authenticates the received public key of the TVPD-HORS using the received authentication path (e.g., TVPD-MHT-NHORS.Ver step 3). Upon the public key verification, the remaining signature verification resembles the TVPD-HORS (e.g., TVPD-MHT-NHORS.Ver steps 4-11). The verifier updates the State variable as a counter if the application is not time-valid (e.g., TVPD-MHT-NHORS.Ver step 10).

Algorithm 3 Time Valid Probabilistic Data Structure MHT N one-time HORS (TVPD-MHT-NHORS)

| | (msk, PK, \vec{I}) ← TVPD-MRT-NHORS.Kg(1^{κ}, N) |
|---|---|
| 1: | Given κ, generate the time epoch T_{Δ} |
| 2: | Given κ, generate N system-wide parameters \vec{I} ← {(lᵢ, kᵢ, tᵢ, pᵢ, nᵢ, T_{Δ})}ᵢ₌₁^{N} for N_{TVPD-HORS} |
| 3: | $msk {⟵}^{\$} {\{ 0 , 1 \}}^{κ}$ |
| 4: | for i from 1 to N do |
| 5: | Set (l, k, t. p, n) ← \vec{Iᵢ} |
| 6: | Generate bυᵢ[.] containing p partitions {Pᵢ}ᵢ₌₁^{p} as stated in Definition 2 and set all the bits to 0 |
| 7: | $Generate t random l - bit strings {\{ {s}_{i} \}}_{i = 1}^{l} : {s}_{i} {⟵}^{\$} PRF ( msk , i ) , ∀ i = 1 ∈ ( 1 , t )$ |
| 8: | $Insert {\{ {s}_{i} \}}_{i = 1}^{t} , ∀ i ∈ [ 1 , t ] into the b υ [ . ] by setting the bit ( h ( {s}_{i} ) mod {n}_{j} ) of {j}^{th} partition to 1 , ∀ j ∈ [ 1 , p ]$ |
| 9: | \vec{BF} ← (bυ₁[.]\|\|1, bυ₂[.]\|\|2, ... , bυ_{N}[.]\|\|N) |
| 10: | Build a Merkle tree on top of all the N public keys to obtain the root as (Root, E₁) ← MHT.build(\vec{BF}) |
| 11: | if κ is not high security level then |
| 12: | Set the signer (Tₛ) and the verifier (T_{υ}) times to T₀ // T_{Δ} is κ dependent and can be for hours/days |
| 13: | State ← 1 |
| 14: | return (msk, Root, \vec{I}) |
| | σ ← TVPD-MRT-NHORS.Sig(msk, m) |
| 1: | $if κ is not high security level then State ← ⌊ \frac{{T}_{s} - {T}_{0}}{{T}_{Δ}} ⌋ + 1$ |
| 2: | if Eᵣ does not authenticate the bυ[.] of the current state then Eᵣ₊₁ ← MHT.evolve(Eᵣ) |
| 3: | Extract the TVPD-HORS keys of the current state from the current E_{r′} as {sᵢ}ᵢ₌₁^{t}, ∀i ∈ [1, t] |
| 4: | Compute the authentication path for the PK of the current state using Auth ← MHT.auth(bυₛₜₐₜₑ[.]\|\|State) |
| 5: | Ctr ← 0 |
| 6: | hash ← H (m\|\|Ctr) |
| 7: | hash' ← Trunc(hash, k log t) // Truncate the hash to the length k log t based on the given κ |
| 8: | Split the truncated hash, hash′, into k substrings {hashⱼ′}ⱼ₌₁^{k} such that \|hashⱼ′\| = log t |
| 9: | Interpret each hashⱼ′ as an integer iⱼ, ∀j ∈ {1, 2, ... , k} |
| 10: | if there exist p, q ∈ {1, 2, ... k} such that iₚ = i_{q} and p ≠ q, then Ctr ← Ctr + 1 and goto 6 |
| 11: | $Set σ ← ( {\{ {s}_{{i}_{j}} \}}_{j = 1}^{k} , Auth , Ctr , PK )$ |
| 12: | if κ is high security level then State ← State + 1 |
| 13: | return σ |
| | b ← TVPD-MHT-NHORS.Ver(Root, PK, m, σ) |
| 1: | $Recall that σ ← ( {\{ {s}_{i}^{′} \}}_{i = 1}^{k} , Auth , Ctr , PK ) and PK ← b υ [ . ]$ |
| 2: | $if κ is not high security level then State ← ⌊ \frac{{T}_{s} - {T}_{0}}{{T}_{Δ}} ⌋ + 1$ |
| 3: | if MHT.authver(PK\|\|State, Auth) is rejected, then then b = 0 and goto 10 |
| 4: | hash ← H(m\|\|Ctr) |
| 5: | hash′ ← Trunc(hash, k log t) // Truncate the hash to the length k log t based on the given κ |
| 6: | $Split the truncated hash , {hash}^{′} , into k substrings {\{ {hash}_{j}^{′} \}}_{j = 1}^{k} , where \vert {hash}_{j}^{′} \vert = log t , ∀ j ∈ \{ 1 , 2 , … , k \}$ |
| 7: | Interpret each hashⱼ′ as an integer iⱼ, ∀j ∈ {1, 2, ... , k} |
| 8: | if there exist p, q ∈ {1, 2, ... k} such that iₚ = i_{q} and p ≠ q, then b = 0 and goto 10 |
| 9: | if the bit indices (h(sⱼ′) mood nᵢ) of the i^{th} partition are set, ∀j ∈ {1, 2, ... , k}, ∀i ∈ [1, p] then b = 1 else b = 0 |
| 10: | if κ is high security level then State ← State + 1 |
| 11: | return b |

The described technology may be applicable to any number of additional techniques. For example, the utilization of OHBF may enhance other signature schemes computationally. Various example implementations include:

Signer Efficient Multiple-time Implementation: This implementation introduces the Signer Optimal N-HORS (SON-HORS) signature scheme, which is designed to support multiple-time (N time) signatures. Leveraging the efficient key generation and signature verification of the TVPD-HORS scheme, SON-HORS is signer optimal as it requires only a single call to generate the current state's keys and update the current seed. The specifics of this implementation are outlined as follows:

Key Generation: Given an initial seed₀ [symbol] {0, 1}^{κ}, a chain of seeds is generated as seedᵢ←H^{t}(seedᵢ₋₁∥0) The intention for concatenating with a value (e.g., 0) is to derive multiple hash values from a single fixed input (e.g., seedᵢ). This technique is helpful in key generation and signature generation, where a new value has to be derived from the current state's seedᵢ. Each seedᵢ is then used to generate private

$$( {\{ {s}_{j}^{i} \}}_{j = 1}^{t} )$$

and public key ({PKⱼⁱ←bvᵢ[·]}) pairs of the underlying TVPD-HORS.

Signature Generation: Given the initial seed, seed₀, the signer in each round j evolves the seed as seedⱼ←H(seedⱼ₋₁∥0) and deletes seedⱼ₋₁ from memory. Given seedⱼ, the signer generates the TVPD-HORS's private key

$$( {\{ {s}_{i}^{j} \}}_{i = 1}^{i} )$$

and generates the public key's pad as rⱼ←H(seedⱼ∥1). Further, having the private key of the current state, the signing procedure resembles the TVPD-HORS where a Ctr is found for a weak message, and the H(m∥Ctr) is truncated and divided into k parts of log t size. The signer then outputs

$$( {σ}_{j} = {\{ {s}_{i}^{j} \}}_{i = 1}^{k} , Ctr , {r}_{j} )$$

as the signature. In some examples rⱼ is sent (e.g., as opposed to r′ⱼ←PRF(rⱼ))

Signature Verification: Given a message-signature pair, the Ctr and the public key pad rⱼ received in state j, the verifier follows a similar procedure as TVPD-HORS by first checking if the Ctr is acceptable. Further, it truncates the hash H(m∥Ctr) and splits it into k parts of log t size. To check if the received signature is valid, the verifier checks if the signature portions exist in the public key (bvⱼ[·]). To unmask the public key, the verifier first extends the received rⱼ to match the size of the public key (r′ⱼ←PRF(rⱼ)) and then unmasks it by bv′ⱼ[·]←bv′ⱼ[·]⊕ r′ⱼ. Having the unmasked public key (bv′ⱼ[·]), the rest of the signature verification resembles the TVPD-HORS.

Example implementations of this implementation permit long-term and sustainable signature services. For instance, consider a smart grid meter reporting its status every 10 minutes and wanting to supply the keys for six months to one year. This requires the number of keys to be at least 2\hat{ }15 and 512 MBs of masked public keys to be stored on the verifier for 128-bit security. Masking TVPD-HORS's public key with a pad protects them against quantum computers while being stored on the verifier side for a considerable amount of time (e.g., six months). Forward security is provided as the signer in each step evolves the seed seedⱼ←H(seedⱼ₋₁∥0) and deletes the previous seed seedⱼ₋₁. Exploiting the efficient signature verification of the underlying TVPD-HORS has made this scheme verifier computationally efficient in addition to signer optimality with the tradeoff of requiring to store a linear number of public keys (N) in the verifier.

Hardware-supported Signatures: Some examples may utilize Trusted Execution Environments (TEEs) like Intel Software Guard Extensions (SGX) to enhance cryptographic functionalities. For example, hardware-supported digital signatures that utilize Intel SGX can eliminate the need for signers to supply commitments and public keys (with certificates), potentially serving as a basis for extending current constructions to support faster key generation. In this extension, the verifier is equipped with a secure enclave while the signer remains unchanged. For key generation, the initial seed, seed₀ [symbol] {0,1}^{κ}, is sent both to the signer and the verifier and stored in the verifier's secure enclave during the offline mode. In online mode and in each round j, both the signer and the verifier generate the TVPD-HORS's private key ({sᵢ^{j}}ᵢ₌₁^{t}) and public keys bvⱼ[·] from the current state's seed seedⱼ←H(seedⱼ₋₁∥0) and delete the previous one seedᵢ₋₁. The difference between the signer and verifier in this stage is that the verifier performs the above operations in a secure enclave where an attacker cannot access the seed and private keys. Upon generating the public key, the verifier fetches bvⱼ[·] from the secure enclave and puts it into the main memory. After deriving the keys, the signer performs signature generation the same as TVPD-HORS and sends the signature to the verifier. The verifier performs the signature verification the same as TVPD-HORS. There is no need for the secure enclave to reside on the verifier. For instance, if the verifier is not a resourceful system equipped with a secure enclave (e.g., mobile phone), it can ask for the public key from another system with a secure enclave and derive the keys. In this scenario, the initial seed needs to be transferred to the third system in the offline mode.

Sustainable Transmission Implementation: Packet loss is more prevalent in WSNs than in typical Internet environments due to unreliable wireless communication or malicious jamming. Various efficient approaches have been proposed to address these issues, such as adopting forward error correction techniques, erasure codes, and anti-jamming techniques. As time-valid applications (e.g., WSNs) are susceptible to packet loss, error correction codes are added to a scheme employing batch communication of public keys. In this implementation, in each round, in addition to communicating the signature same as TVPD-HORS, the signer sends 1 number of future public keys with the signature as well. The parameter 1 is adjustable, making the size of added public keys to the signature constant with respect to the parameter 1. Further, the signer adds an elliptic-curve-based signature (e.g., ECDSA) to the added public keys such that the verifier can authenticate those alongside the signature. However, as the signature size increases, the packet loss ratios increase in unreliable wireless environments. To mitigate such an issue, error correction codes are added to the signature, which are computed based on the added public keys and can later be verified by the verifier. This way, in each round, multiple public keys are communicated, which can be served for multiple rounds in the future, and they are made robust against packet losses by adding error correction codes.

Example implementations of Tree-based Signatures: Tree-based FTSs such as HORST and XMSS utilize the Merkle tree to authenticate private and public keys, respectively. However, constructing the tree and extracting authentication paths for each leaf becomes time-consuming and resource-intensive as the number of leaves increases. To address this, caching upper tree layers and sending them to the verifier instead of the root can accelerate tree construction and shorten authentication paths. Leveraging OHBF for efficient insertion, interior nodes can be efficiently inserted into the OHBF (as the root), which is more efficient than using secure hash functions and can result in enhanced tree construction, authentication path extraction, and authentication path verification.

Example implementations of Chain-based Signatures: Chain-based FTSs like HORSIC and HORSIC+, primarily relying on WOTS, can leverage OHBF for two optimization opportunities. Firstly, instead of using a cryptographically secure hash function to derive the commitment of all chains, the last key of each chain can be directly inserted into the OHBF (as the commitment). Given that OHBF insertion is more efficient than a secure hash function, constructing the commitment can be significantly improved. Secondly, signature elements (private keys of the chains) must be authenticated during signature verification using the constructed commitments. This process involves hashing the private keys multiple times in the chain and comparing the result with the commitment. However, long chains increase hash calls and slow down the process. To mitigate this issue, partitioning the chain into multiple parts and using an OHBF for each part as the commitment is proposed. Consequently, signature elements (private keys) can be committed to the corresponding OHBF based on which partition they reside.

Example implementations of Key Generation: In the second design (TVPD-MHT-NHORS), the key generation phase presents computational overhead due to the construction of the Merkle tree. To address this challenge, leveraging Chameleon hash functions (CHFs) offers a potential improvement opportunity. CHFs facilitate the generation of random values instead of constructing public keys of all the OTSs for extracting the root. Consequently, the tree's root (commitment) can be generated and transmitted to the verifier. During each round, when an OTS (leaf) of the tree is needed, the private and public keys are generated, and the signer (CHF's private key holder) considers the generated public key as the collision for the previously generated leaf, yielding a random value sent with the signature. This random value, combined with the public key, ensures that the public key's CHF hash is the same as the old randomly generated value's CHF hash value. While this construction yields a lighter key generation phase, the signing and verification phases incur slightly greater costs. By appropriately instantiating the CHF, rapid signing procedures and optimal storage requirements on the signer's side can be achieved.

### Performance Comparison and Security Analysis of TVPD-HORS

TVPD-HORS was evaluated on commodity hardware equipped with an Intel i9-11900K@3.5 GHz processor and 64 GB of RAM. The evaluation utilized (i) LibTomCrypt to implement SHA2(256/512) hash functions, (ii) the Blake2 hash family, and (iii) CityHash and xxHash3 as OHBF's hash function.

The comparative analysis between TVPD-HORS and HORS extends across various security levels, with 32-bit to 64-bit levels deemed more appropriate for time-sensitive applications. Higher security levels (ranging from 72-bit to 128-bit) have also been integrated to cater to non-time-critical scenarios. The adjustment of security levels is based on the system's cryptographic elements. Specifically, the inclusion of hash functions with longer output lengths (e.g., SHA2-512 instead of SHA2-256), increasing p of the underlying OHBF, and one-way functions with extended outputs (e.g., CityHash256 instead of xxHash3-64) facilitates the transition from lower security levels to higher ones. A black row in the performance comparison tables separates the security levels for time-sensitive and non-time-critical applications.

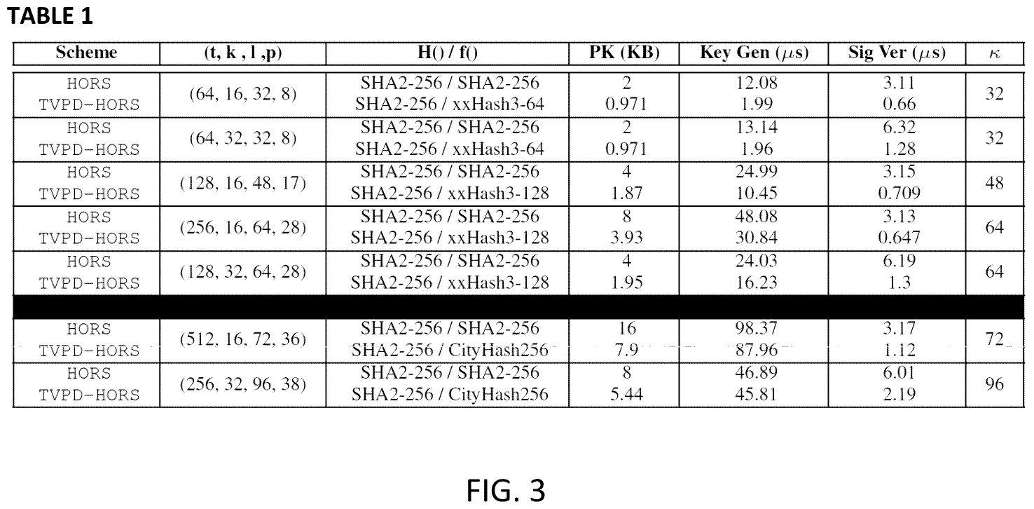

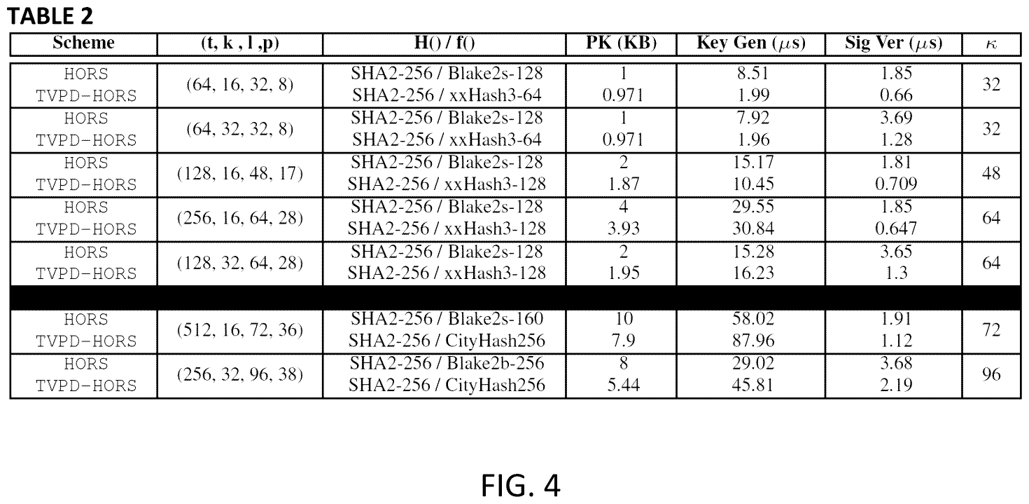

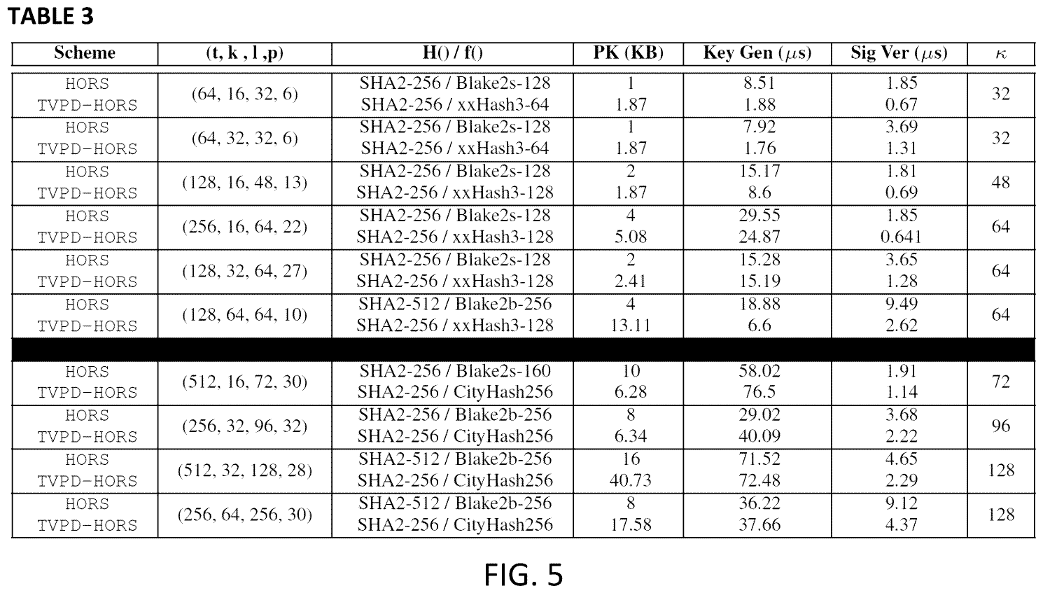

Table 1 (FIG. 3) provides a conventional comparison, where the HORS's OWF is instantiated with the widely utilized SHA2-256 hash function. Conversely, the TVPD-HORS's OWF employs the xxHash3 hash family (xxHash3-64, xxHash3-128) and the CityHash hash family (CityHash256). Within this table, the size of the OHBF remains either equivalent to or smaller than the size of HORS's public key while allowing for an increase in p (the number of partitions and modulo operations). This ensures that TVPD-HORS and HORS stay the same in all aspects, with the comparison focusing on key generation and signature verification. To tailor HORS for time-valid applications, its OWF is instantiated using the Blake2 hash family (Blake2s-128, Blake2s-160, Blake2s-256), known for their security and superior efficiency compared to SHA2 counterparts. With identical parameter configurations, the performance of TVPD-HORS remains consistent, as it is already instantiated with efficient primitives. Table 2 (FIG. 4) compares the time-valid adapted HORS and TVPD-HORS. Previous comparisons maintained TVPD-HORS's public key size equal to or smaller than HORS's by increasing parameter p. However, performance enhancement for TVPD-HORS is possible by reducing p, albeit resulting in larger OHBF (TVPD-HORS's public key). Table 3 (FIG. 5) showcases configurations where public key size increase enhances performance, beneficial in communication-unrestricted applications. This adjustment also allows TVPD-HORS to operate at higher security levels (128-bits). The private key size for both the HORS and TVPD-HORS is computed as t·l. However, in practice, private keys are generated from a seed of constant size. Thus, the private key's size is considered constant. The PK column for TVPD-HORS shows the size of the OHBF. The signature size for both HORS and TVPD-HORS is computed as k·l plus the size of the Ctr variable. The signature generation time for both HORS and TVPD-HORS is the same since all functionalities are identical. Despite adding resistance against weak message attacks in TVPD-HORS, we can also incorporate this enhancement into HORS.

The overall security (κ) of the scheme is defined based on the security of the HORS signature and the security of the incorporated OHBF:

$$κ = min ( \frac{k log t}{2} , \frac{L}{2} , k ( log t - log k - log r ) , \frac{{L}^{′}}{2} , {log ( 1 - \sqrt[p]{{\prod }_{i = 1}^{p} {e}^{- \frac{N}{{n}_{i}}}} )}^{- p} )$$

Employing the HORS signature as an OTS, the parameter r is set to 1. The number of items for insertion into the OHBF (N) is the number of HORS's private keys (t). Thus:

$$κ = min ( \frac{k log t}{2} , \frac{L}{2} , k ( log t - log k ) , \frac{{L}^{′}}{2} , {log ( 1 - \sqrt[p]{{\prod }_{i = 1}^{p} {e}^{- \frac{t}{{n}_{i}}}} )}^{- p} )$$

To exemplify the computation of κ, consider the first setting of Table 1, where t=64, k=16, 1=64, n=0.971 KB, p=8, L=256, and L′=64. This results in sk=tl=0.5 KB and the public key size of HORS being t. L=2 KB. By adjusting parameters and considering the security parameter κ, the partitions of the OHBF are:

$${\{ {P}_{i} \}}_{i = 1}^{8} = [ 971 , 977 , 983 , 991 , 1009 , 1013 , 1019 ]$$

Given the use of SHA2-256 for message hashing in both HORS and TVPD-HORS, Blake2s-128 for the OWF of HORS, and xxHash3-64 as the h( ) of the OHBF, the parameters are substituted into the κ's formula:

$$κ = min ( \frac{16 * 6}{2} , \frac{256}{2} , 16 ( log 64 - log 16 ) , \frac{64}{2} , {log ( 1 - \sqrt[8]{{\prod }_{i = 1}^{8} {e}^{- \frac{64}{{n}_{i}}}} )}^{- 8} ) = 32$$

The relationship between quantum attack effectiveness against hash functions (e.g., Grover's algorithm) and the security strength of hash-based schemes is crucial to acknowledge. When using a perfect hash function with an output of L bits, the likelihood of finding a collision from 2L guesses without prior knowledge forms a binomial distribution converging to 63.2%. Grover's algorithm demonstrates the capability to reverse a black-box function implemented as a quantum oracle with a time complexity of O(√N) where N is the size of the input space. This algorithm efficiently executes quantum attacks by directly identifying collisions through amplitude amplification. However, determining the precise number of search targets is a significant challenge. Moreover, for hash functions such as SHA2-256, the huge search space required to find collisions with non-negligible probability poses a substantial obstacle, even for Grover's algorithm. As an illustration, even with a trillion operations per second, the time required for finding a collision for SHA2-256 using Grover's algorithm is estimated at 10\hat{ }19 years. Therefore, adjusting the security bit according to application requirements ensures security against such attacks across various timeframes while improving performance.

Based on the tables (1-3), the enhancements can be summarized as follows:

Key Generation: Based on the classical comparison presented in Table 1, key generation is 1.5-6× faster for low to moderate security levels (32-bits to 64-bits), 1.2× in 72-bits, and comparable in 96-bits for high-security levels. Note that in this table, as the size of the TVPD-HORS's public key is restricted, the analysis won't include 128 bits as it requires larger public keys. In Table 2, where HORS is adapted for time-valid applications, the scheme shows 4.2× faster key generation for low-security levels and comparable performance for moderate to high-security levels (64-bits to 96-bits). Lastly, in Table 3, where the size of the OHBF is allowed to increase for performance improvements, the scheme shows 1.7-4.5× improvement for low-security levels and comparable performance for moderate to high-security levels. However, in one moderate setting where (t, k, l, p)←(128, 64, 64, 10), key generation is 2.8× faster.

Signature Generation: The signature generation of the scheme resembles that of the HORS scheme. While security has been enhanced by mitigating the risk of weak message attacks, which incurs additional overhead, it's noteworthy that this security enhancement can also be applied to the HORS scheme. Consequently, there exists no performance difference between TVPD-HORS and HORS.

Signature Verification: The efficiency of OHBF is notably highlighted in the signature verification process. In the classical comparison provided in Table 2, the signature verification shows an improvement of 4-5× for low to moderate security levels and around 2.7× for high-security levels. Moreover, when HORS is tailored for time-valid applications (Table 2), the scheme exhibits faster verification of 2.8× for low to moderate security levels and 1.8× for high-security levels. Lastly, in Table 3, where the OHBF's size is increased for better performance, signature verification is 2.8-3.6× faster in low to moderate security levels and 1.6-2× faster in high-security levels.

### Performance Comparison and Security Analysis of TVPD-MHT-NHORS

Hardware and Software Configuration: TVPD-HORS was evaluated on commodity hardware equipped with an Intel i9-11900K@3.5 GHz processor and 64 GB of RAM. The evaluation utilized (i) LibTomCrypt to implement SHA2(256/512) hash functions, (ii) Blake2 hash family, and (iii) CityHash and xxHash3 as OHBF's hash function.

Performance Analysis: The same methodology employed to evaluate the initial scheme (TVPD-HORS), as described in Tables 1 to 3, was followed for the assessment of TVPD-MHT-NHORS, detailed in Tables 4 to 6. The primary distinction between TVPD-MHT-NHORS and TVPD-HORS arises from the necessity for public keys to be authenticated. To address this requirement, TVPD-MHT-NHORS utilizes the optimized Merkle tree (See Definition 3). TVPD-MHT-NHORS integrates the MHT.build( ) in key generation, MHT.evolve( ) and MHT.auth( ) in signature generation, and MHT.authver( ) in signature verification, all employing SHA2-256. Therefore, in this scheme, the time complexity of the optimized Merkle tree will be added to the time complexities of TVPD-HORS.

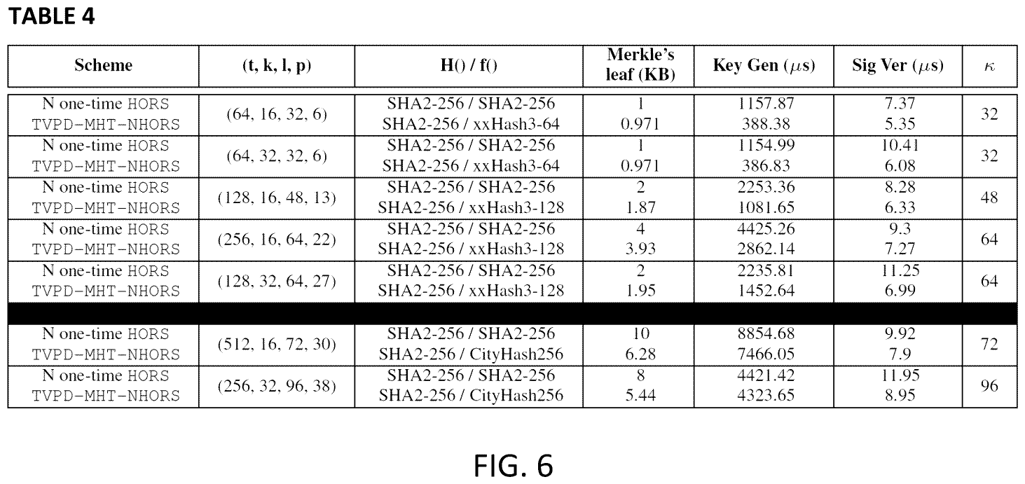

Table 4 (FIG. 6): Classical performance comparison of N one-time HORS (f ( ): SHA2 family) and TVPD-MHT-NHORS (f ( ): xxHash3 and CityHash families). N: 64, Message size: 256 Bytes. Maintaining TVPD-HORS's PK (Merkle tree's leaf) the same or smaller than HORS's PK while increasing p. The private key size for both HORS and TVPD-MHT-NHORS is calculated as t·1. However, in practice, private keys are generated from a seed of constant size, making the private key's size constant. The public key is the Merkle tree's root, which is 256 bits in size due to using SHA2-256 for constructing the tree. The signature for both HORS and TVPD-MHT-NHORS have identical parts of size k·1, Ctr variable, and the authentication path, which is log t×256 bits. However, the signature holds the Merkle's leaf, the public key of the currently used TVPD-HORS which can be different in size compared to HORS. The signature generation time for both schemes is identical, as all functionalities are the same. Despite incorporating resistance against weak message attacks in the underlying TVPD-HORS of TVPD-MHT-NHORS, this enhancement can also be applied to HORS as the underlying N one-time HORS scheme.

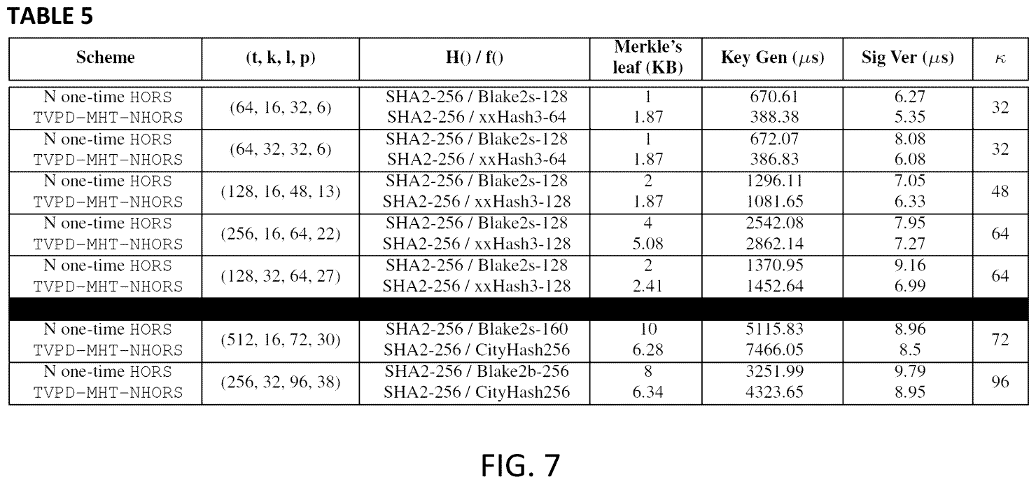

Table 5 (FIG. 7): Performance comparison of N one-time HORS (f ( ): Blake2 family) and TVPD-MHT-NHORS (f ( ): xxHash3 and CityHash families). N: 64, Message size: 256 Bytes. Maintaining TVPD-HORS's PK (Merkle tree's leaf) the same or smaller than HORS's PK while increasing p.

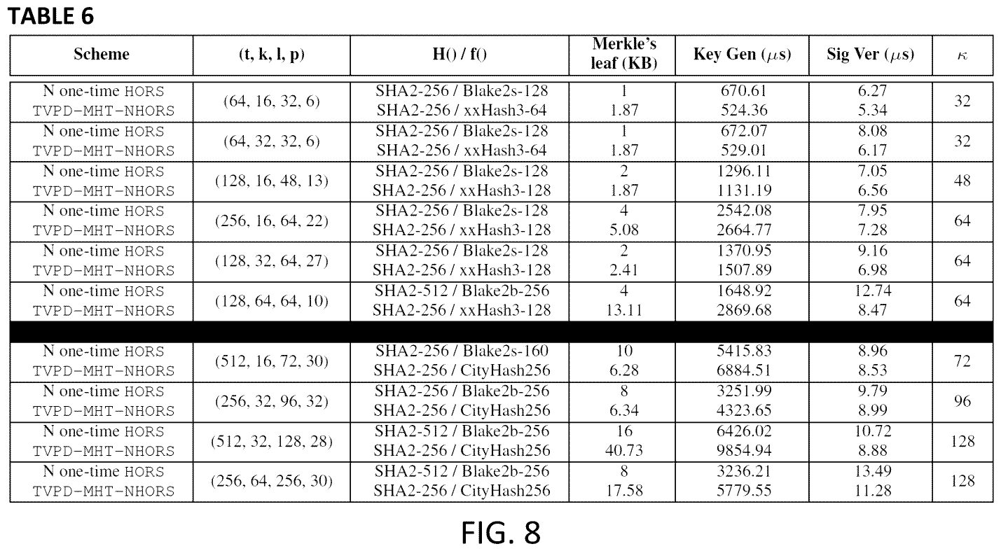

Table 6 (FIG. 8): Performance comparison of N one-time HORS (f ( ): Blake2 family) and TVPD-MHT-NHORS (f ( ): xxHash3 and CityHash families). N: 64, Message size: 256 Bytes. Maintaining small p while increasing TVPD-HORS's PK (Merkle tree's leaf) size.

The overall security (in terms of security bits) of TVPD-MHT-NHORSremains same as the TVPD-HORS:

$$κ = min ( \frac{k log t}{2} , \frac{L}{2} , k ( log t - log k ) , \frac{{L}^{′}}{2} , {log ( 1 - \sqrt[p]{{\prod }_{i = 1}^{p} {e}^{- \frac{t}{{n}_{i}}}} )}^{- p} )$$

Based on the Tables (4-6), the enhancements can be summarized as follows:

Key Generation: According to the classical comparison provided in Table 4, TVPD-MHT-NHORS is 1.5-2.9 times faster at low to moderate security levels, 1.2 times faster at 72-bits, and comparable at 96-bits. In the subsequent comparison, Table 5, where N one-time HORS is adapted for time-valid applications, the scheme is 1.7 times faster at low-security levels and comparable for moderate to high-security levels. Lastly, by allowing the OHBF's size to increase for better performance, as shown in Table 6, the speedup is 1.3 times in low-security models and comparable in moderate to high-security levels. It is noted that the increase in the size of the public key clearly shows its performance impact on 128-bit security levels and the 64-bit level setting ((t, k, l, p)←(128, 64, 64, 10)), which is due to the overhead of MHT.build( ).

Signature Generation: The signature generation process resembles that of N one-time HORS. All operations involving the Merkle tree and eliminating weak message risks are identical. It is noted that as the size of the OHBF is increased, particularly in Table 6, the overhead of Merkle tree operations during signature generation is slightly increased.

Signature Verification: In Table 4, a speedup of 1.4-1.7 times is observed for low to moderate security levels and 1.2-1.3 times for high-security levels. In Table 5, where N one-time HORS is adopted for time-valid applications, a speedup of 1.2-1.4 times is achieved for low to moderate security levels and 1.2 times for high-security levels. Lastly, in Table 6, where the OHBF size is allowed to increase, performance improvement of 1.2-1.5 times is achieved for low to moderate security levels and 1.3 times for high-security levels. It is noted that the significant performance improvement of the underlying TVPD-HORS is concealed due to the overhead of the MHT.authver( ).

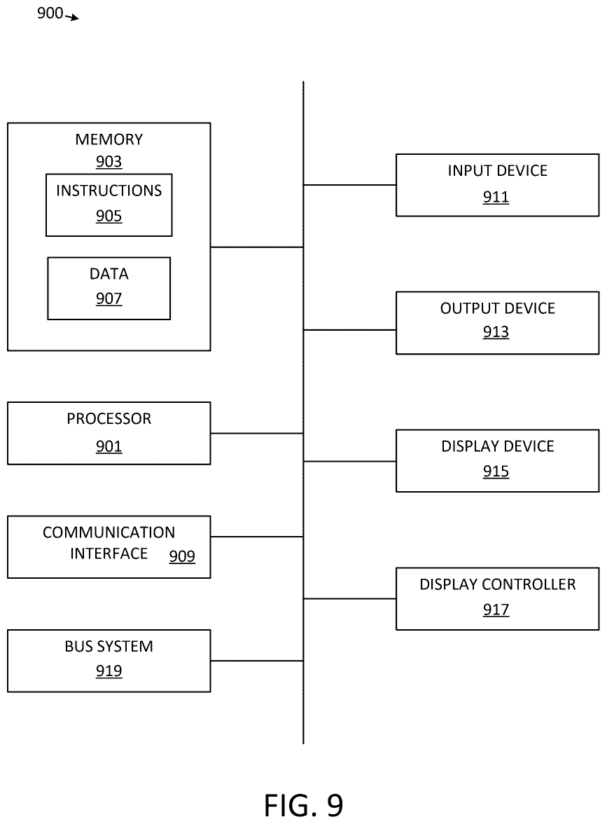

FIG. 9 illustrates certain components that may be included within a computer system 900, which may be used to control features according to embodiments of the present disclosure, such as the features discussed with reference to FIGS. 1-8. One or more computer systems 900 may be used to implement the various devices, components, and systems described herein.

The computer system 900 includes a processor 901. The processor 901 may be a single processor or may include multiple processors and/or sub-processors. The processor 901 may be a general-purpose single- or multi-chip microprocessor (e.g., an Advanced RISC (Reduced Instruction Set Computer) Machine (ARM), and x86 processor), a special-purpose microprocessor (e.g., a digital signal processor (DSP)), a microcontroller, a programmable gate array, etc. The processor 901 may be referred to as a central processing unit (CPU). Although just a single processor 901 is shown in the computer system 900 of FIG. 9, in an alternative configuration, a combination of processors (e.g., an ARM and DSP) could be used. In one or more embodiments, the computer system 900 further includes one or more graphics processing units (GPUs), which can provide processing services related to both entity classification and graph generation.

The computer system 900 also includes memory 903 in electronic communication with the processor 901. The memory 903 may be any electronic component capable of storing electronic information. For example, the memory 903 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, at least one non-transitory computer-readable and/or processor-readable medium, and so forth, including combinations thereof. The memory may include a single memory device or multiple memory devices.

Instructions 905 and data 907 may be stored in the memory 903. The instructions 905 may be executable by the processor 901 to implement some or all of the functionality disclosed herein. Executing the instructions 905 may involve the use of the data 907 that is stored in the memory 903. Any of the various examples of modules and components described herein may be implemented, partially or wholly, as instructions 905 stored in memory 903 and executed by the processor 901. Any of the various examples of data described herein may be among the data 907 that is stored in memory 903 and used during execution of the instructions 905 by the processor 901.

A computer system 900 may also include one or more communication interfaces 909 for communicating with other electronic devices. The communication interface(s) 909 may be based on wired communication technology, wireless communication technology, or both. Some examples of communication interfaces 909 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 900 may also include one or more input devices 911 and one or more output devices 913. Some examples of input devices 911 include a keyboard, mouse, microphone, remote control device, button, joystick, trackball, touchpad, and lightpen. Some examples of output devices 913 include a speaker and a printer. One specific type of output device that is typically included in a computer system 900 is a display device 915. Display devices 915 used with embodiments disclosed herein may utilize any suitable image projection technology, such as liquid crystal display (LCD), light-emitting diode (LED), gas plasma, electroluminescence, or the like. A display controller 917 may also be provided, for converting data 907 stored in the memory 903 into text, graphics, and/or moving images (as appropriate) shown on the display device 915.

The various components of the computer system 900 may be coupled together by one or more buses, which may include a power bus, a control signal bus, a status signal bus, a data bus, etc. For the sake of clarity, the various buses are illustrated in FIG. 9 as a bus system 919.

Systems and software, e.g., implemented on a non-transitory computer-readable medium, for performing the methods discussed herein are also within the scope of embodiments of the present disclosure.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system.

Computer-readable media that store computer-executable instructions (or software instructions) are designed to temporarily or permanently hold software instructions. Examples include memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

The term “execution by a computer” as used herein refers to the performance of operations, tasks, or functions by a computing device or system, including but not limited to, in various execution environments such as bare metal, virtual machines, containers, and any other computing environments. Execution by a computer includes a computer making a remote function call to another computer, where the first computer initiates and executes the function. This definition encompasses scenarios where operations are executed using one or more types of accelerators, such as digital signal processors (DSPs), neuromorphic chips, application-specific integrated circuits (ASICs), or other specialized processing units. In such instances, the processor of the computer may delegate specific tasks to these accelerators to enhance performance, efficiency, or capability.

Furthermore, the term “execution by a computer” includes the execution of software, instructions, or algorithms stored on computer-readable media. It covers any combination of hardware, firmware, and software components required to perform the desired operations. This definition should be interpreted broadly to include any system where a computer or computing device carries out the execution of tasks, whether the tasks are performed locally, remotely, or distributed across multiple computing environments and devices.

The term “computer” as used herein refers to any general-purpose or special-purpose computing device capable of processing instructions and performing operations, including, but not limited to microprocessors, microcontrollers, DSPs, neuromorphic chips, ASICs, programmable gate arrays, or any combination thereof. The computer may operate standalone or as part of a network or a larger system, and may communicate with other electronic devices and systems through various communication interfaces and protocols.

The definitions provided herein are intended to encompass the broadest possible scope of execution by a computer, reflecting the diverse and evolving nature of computing technologies and environments. All variations, modifications, and equivalents that fall within the spirit and scope of the claims are intended to be embraced by the claims.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

As used in this specification and the claims, the singular forms “a,” “an,” and “the” include plural forms unless the context clearly dictates otherwise. The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims. Any trademarks mentioned herein are the property of their respective owners.

As used herein, the term “random” represents an outcome or value that is produced without a clear pattern or predictability. For example, the term “random” may refer to values that are generated by an algorithm or process designed to produce results that mimic true randomness, such as pseudorandom values. Further, it should be understood that any uses of the term “random” in the preceding description are intended to include both truly random and pseudorandom values. If there are uses of the term that are not clear to persons of ordinary skill in the art given the context in which it is used, “random” will mean values or outcomes that appear to be without pattern or predictability, regardless of the method of generation.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean up to plus or minus 10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not underlyingly alter the nature of the claimed subject matter. Any trademarks are the property of their respective owners.

The phrase “such as” should be interpreted as “for example, including.” Moreover, the use of any and all example language, including but not limited to “such as”, is intended merely to better illuminate the invention and does not pose a limitation on the scope of the invention unless otherwise claimed.

Furthermore, in those instances where a convention analogous to “at least one of A, B and C, etc.” is used, in general such a construction is intended in the sense of one having ordinary skill in the art would understand the convention (e.g., “a system having at least one of A, B and C” would include but not be limited to systems that have A alone, B alone, C alone, A and B together, A and C together, B and C together, and/or A, B, and C together.). It will be further understood by those within the art that virtually any disjunctive word and/or phrase presenting two or more alternative terms, whether in the description or figures, should be understood to contemplate the possibilities of including one of the terms, either of the terms, or both terms. For example, the phrase “A or B” will be understood to include the possibilities of “A” or “B” or “A and B.”

All language such as “up to,” “at least,” “greater than,” “less than,” and the like, include the number recited and refer to ranges which can subsequently be broken down into ranges and subranges. A range includes each individual member. Thus, for example, a group having 1-3 members refers to groups having 1, 2, or 3 members. Similarly, a group having 6 members refers to groups having 1, 2, 3, 4, or 6 members, and so forth.

The modal verb “may” refers to the preferred use or selection of one or more options or choices among the several described embodiments or features contained within the same. Where no options or choices are disclosed regarding a particular embodiment or feature contained in the same, the modal verb “may” refers to an affirmative act regarding how to make or use an aspect of a described embodiment or feature contained in the same, or a definitive decision to use a specific skill regarding a described embodiment or feature contained in the same. In this latter context, the modal verb “may” has the same meaning and connotation as the auxiliary verb “can.”

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method of generating a digital signature for a message, comprising:
obtaining the message;
obtaining a signing private key;
dividing the signing private key into a plurality of indexed values;
identifying a counter value that provides a set of partitions having unique integer interpretations via at least one round of:
combining the message with the counter value;
hashing the combined message and the counter value to generate a hash;
reducing the hash to a predetermined length to generate a reduced hash;
partitioning the reduced hash into a plurality of partitions;
if the plurality of partitions are not interpretable as a set of unique integers, incrementing the counter value for a next round;
if the plurality of partitions are interpretable as a set of unique integers, providing the counter value;
selecting a set of values from the signing key indexed by the unique integers; and
outputting the digital signature comprising the selected set of values and the counter.

2. The method of claim 1, further comprising:
generating a plurality of signing private and public keys;
generating a Merkle tree using the signing public keys; and
providing the root of the tree as a global public key;
wherein the digital signature further comprises an authentication path to the root.

3. The method of claim 2, further comprising:
generating a master key;
generating a plurality of sets of random bit strings as signing private keys using the master key;
generating a bit vector using one-hash bloom filters applied to each signing private key;
generating the Merkle tree using the plurality of bit vectors.

4. The method of claim 1, further comprising:
determining a seed value for a current signing round;
generating the signing private key using the seed value; and
generating a pad for a signing public key corresponding to the signing private key by hashing the seed value for the current signing round;
wherein the digital signature further comprises the seed value for the current signing round.

5. The method of claim 1, further comprising:
generating a plurality of signing public keys for future verification operations;
generating an elliptic-curve-based signature for the plurality of signing public keys; and
generating an error correction code for the plurality of signing public keys;
wherein the digital signature further comprises the plurality of signing public keys, the elliptic-curve-based signature, and the error correction code.

6. The method of claim 1, further comprising:
obtaining a Merkle tree over random values;
generating in each of a plurality of signing rounds, the signing private and public keys;
generating a random collision value using a chameleon hash function based on the public key and a previously generated random value; wherein
the digital signature further comprises the collision value.

7. The method of claim 1, further comprising:
generating the signing private key as t random bit strings indexed by t; and
generating a public key as a bit vector by inserting the t random bit strings into the bit vector using a one-hash bloom filter.

8. A method of validating a digitally signed message, comprising:
obtaining a public key comprising an indexed bit vector comprising a plurality of set bits and a plurality of unset bits;
receiving the digitally signed message comprising a message and a digital signature, the digital signature comprising a counter value and a set of values selected from a signing private key comprising a plurality of indexed values;
combining the message and the counter value;
hashing the combined message and counter value to generate a hash;
generating a reduced hash based on the hash;
partitioning the reduced hash into a plurality of partitions that are interpretable as integers;
if the integers are not unique, identifying the signature as invalid;
for each respective partition of the plurality of partitions, hashing each value of the set of values and performing a modulo operation the hashed value using the integer corresponding to a partition size of the respective partition to determine a respective set of indices;
if any of the indices of the bit vector are not set, identifying the message as invalid.

9. The method of claim 8, wherein the signing public key comprises a root of a Merkle tree, the method further comprising:
receiving an authentication path;
validating the authentication path based on the root and a maintained state;
if the authentication path is not valid, identifying the signature as invalid.

10. The method of claim 9, further comprising, responsive to the authentication path not being valid, advancing the maintained state to a next maintained state.

11. The method of claim 8, wherein the digital signature comprises a pad seed, the method further comprising:
inputting the pad seed to a pseudorandom function to determine an extended pad; and
generating an unmasked public key comprising a bit vector by combining the extended pad with the public key.

12. The method of claim 8, further comprising:
storing an initial seed in a trusted execution environment (TEE);
determining a current seed for a current verification round;
generating a signing private key in the TEE using the current seed; and
generating the signing public key in the TEE using the private key.

13. The method of claim 8, further comprising:
receiving a plurality of signing public keys, an elliptic-curve-based signature for the plurality of public keys, and an error correction code for the plurality of public keys;
validating the plurality of signing public keys using the elliptic-curve-based signature;
storing the plurality of signing public keys; and
selecting a next public key for signature verification.

14. The method of claim 8, wherein the digital signature further comprises a collision value:
receiving a public key for a chameleon hash function; and
verifying a corresponding private key for the chameleon hash function using the signing public key and the collision value.

15. A non-transitory computer readable medium storing executable instructions to sign a message by:
obtaining the message;
obtaining a signing private key;
dividing the signing private key into a plurality of indexed values;
identifying a counter value that provides a set of partitions having unique integer interpretations via at least one round of;
combining the message with the counter value;
hashing the combined message and the counter value to generate a hash;
reducing the hash to a predetermined length to generate a reduced hash;
partitioning the reduced hash into a plurality of partitions;
if the plurality of partitions are not interpretable as a set of unique integers, incrementing the counter value for a next round;
if the plurality of partitions are interpretable as a set of unique integers, providing the counter value;
selecting a set of values from the signing key indexed by the unique integers; and
outputting the digital signature comprising the selected set of values and the counter.

16. The non-transitory computer readable medium of claim 15 storing executable instructions to sign the message by:
generating a plurality of signing private and public keys;
generating a Merkle tree using the signing public keys; and
providing the root of the tree as a global public key;
wherein the digital signature further comprises an authentication path to the root.

17. The non-transitory computer readable medium of claim 15 storing executable instructions to sign the message by:
determining a seed value for a current signing round;
generating the signing private key using the seed value; and
generating a pad for a signing public key corresponding to the signing private key by hashing the seed value for the current signing round;
wherein the digital signature further comprises the seed value for the current signing round.

18. The non-transitory computer readable medium of claim 15 storing executable instructions to sign the message by:
obtaining a Merkle tree over random values;
generating in each of a plurality of signing rounds, the signing private and public keys;
generating a random collision value using a chameleon hash function based on the public key and a previously generated random value; wherein
the digital signature further comprises the collision value.

19. The non-transitory computer readable medium of claim 15 storing executable instructions to validate a second digitally signed message by:
obtaining a second public key comprising an indexed bit vector comprising a second plurality of set bits and a second plurality of unset bits;
receiving the second digitally signed message comprising a second message and a second digital signature, the second digital signature comprising a second counter value and a second set of values selected from a second signing private key comprising a plurality of indexed values;
combining the second message and the second counter value;
hashing the combined second message and second counter value to generate a second hash;
generating a second reduced hash based on the second hash;
partitioning the second reduced hash into a second plurality of partitions that are interpretable as integers;
if the integers of the second plurality are not unique,
identifying the second signature as invalid;
for each respective partition of the second plurality of partitions, hashing each value of the second set of values and performing a modulo operation on the hashed value using the integer corresponding to a partition size of the respective partition to determine a respective set of indices;
if any of the indices of the second bit vector are not set, identifying the second message as invalid.
